(19) United States
(12) Patent Application Publication
(10) Pub. No.: US 2026/0264984 A1
(43) Pub. Date: Sep. 10, 2026

(54) STORAGE SYSTEM WITH FORKLIFT GUARD

(71) Applicant: FRAZIER INDUSTRIAL COMPANY, Long Valley, NJ (US)

(72) Inventor: Emery Louis (Jim) Kocsis, Keller, TX (US)

(21) Appl. No.: 19/070,935

(22) Filed: Mar. 5, 2025

(51) Int. Cl. B65G 1/06; B65G 1/04

(52) U.S. Cl. CPC B65G 1/065; B65G 1/0492; B65G 2201/0267

(57) ABSTRACT

A storage rack system has a pair of vertical columns defining a storage bay. A horizontal connecting beam connects the vertical columns and a top edge of the horizontal beam defines a horizontal plane. The rack includes a pair support rails. Each support rail has an upper pallet support surface for supporting a side edge of a pallet of goods and a lower pallet cart support surface for supporting the wheels of one side of a pallet transportation cart. The support rail can include a vertical lower apron wall extending downward from the cart support surface. In one embodiment of the invention, the lower apron extends below the horizontal plane defined by the horizontal connecting beam. This helps prevent the fork of a forklift from accidentally slipping behind the support rail. In other embodiments of the invention, gap covers can provide a similar benefit.

### BACKGROUND OF THE INVENTION

The disclosure relates to systems and methods for loading, storing, and unloading pallets of goods and pallet transportation carts onto and from supportive structures and more particularly, to a storage bay constructed to permit safer loading and unloading of pallets and pallet transportation pallet carts, with less likelihood of damage occurring to the supportive structures.

Storage systems are used in warehouses, department stores, cold storage areas and other storage facilities to store containers of goods, typically on pallets. Certain storage systems employ extensive storage rack systems, often called deep rack storage, to store large amounts of a variety of different products. Some of these systems have rows of storage bays stacked on top of and side-by-side each other, with two to seven or higher levels. A storage bay typically includes left and right pallet support rail structures extending into the depth of the bays, with the left and right edges of the pallets resting on the pallet support rails. See, e.g., U.S. Pat. No. 10,752,441, the contents of which is incorporated herein by reference.

Modern commercial storage systems employ automated or manually operated pallet transportation carts to move the pallets into and out of the bays. The carts typically travel on pallet cart support rails located under the pallets in the storage bays. See, e.g., U.S. Pat. No. 10,589.929, the contents of which is incorporated herein by reference. The storage bays can be up to 250 feet deep, or longer. To bring a pallet from one area of the bay to another, an automatically raiseable platform of the cart is used to lift the pallet off the pallet support rails and transport it to the desired location in the bay, where it can be lowered back onto the pallet support rails.

A conventional multi-level, multi-column commercial rack storage system having a plurality of stacked side-by-side storage bays 180 is shown in FIG. 1 as a storage system rack 100. Rack 100 corresponds generally to the rack system shown in FIG. 1 of U.S. Pat. No. 10,752,441. Both systems include vertical columns, horizontal beams connecting the columns, and supportive rail structures for supporting the pallets and the pallet carts. However, the rack system in the above referenced '441 patent is drawn schematically. The rails for supporting the pallets and pallet carts have a general L-shaped cross section, with an upper surface for supporting the outer edges of a pallet and a lower surface for the wheels of the pallet cart.

The connective relationship between the prior art pallet/pallet cart support rails and the vertical columns and horizontal beams of the '441 patent is shown schematically. The '441 patent depicts the pallet/pallet cart support rails as resting on the horizontal beams. Those of ordinary skill in the art would understand that in practice, those horizontal beams are provided to connect the vertical columns. They do not typically function as a load bearing surface for all the pallet/pallet cart support rails. Those rails are bolted to the vertical columns and typically do not rest on the horizontal beams. Thus, those of ordinary skill in the art would understand that in the actual implementation of the prior art rack system of the '441 patent, there is a gap between the rails attached to the columns and the horizontal beams that connect the columns, as discussed more fully below.

Rack storage system 100 includes an array of vertical support columns 110, which extend upwards from the floor of a commercial warehouse. A plurality of horizontal beams 115 connect columns 110. Each storage bay 180 includes a pair of left side and right side support rails 120 extending from a front end to a rear end of bay 180. Support rails 120 include a pallet support surface 121, on which the outer edges of a plurality of pallets 130, supporting a variety of goods 131 can be supported.

As indicated above, modern storage systems commonly employ one or more robotic pallet transportation carts 140, for transporting pallets throughout storage system 100. Pallet transportation cart 140 includes a raiseable surface 160, which can be raised up until it contacts and lifts the bottom of pallet 130. Cart 140 also includes four automatically driven wheels 170. Wheels 170 travel on a cart transportation surface 125 of rail 120. Thus, rails 120 extend into storage bay 180 and permit carts 140 to travel under pallets 130 along the entire length of each bay 180.

Rails 120 are typically formed from a sheet of metal formed with top surface 121, and formed to extend down, then bent again to form cart transportation surface 125. They can also be formed as separate elements. It is desirable to save weight and material cost by making the sheet of metal as thin as is practical, as long as it is strong enough for its intended purpose. Furthermore, as shown in FIG. 1, assembly requirements result in a gap between the lower edge of rail 120 attached to column 110 and the top edge of horizontal beam 115. Pallets 130 and pallet carts 140 are frequently removed from rails 120 with a fork 250 (single (not shown) or double) of a forklift 200, shown in FIG. 2.

Referring to FIG. 3, a conventional rack system 300, similar to rack 100, is depicted with a storage bay 380. Rack 300 includes an arrangement of vertical columns 310 connected with a plurality of horizontal beams 315. Bay 380 includes a pair of support rails 320. Support rails 320 include a pallet support top surface 321 for supporting a plurality of pallets 331 and a pallet cart support surface 325 for supporting the wheels of a pallet transportation cart 340.

Pallet of goods 331 and pallet cart 340 will typically be removed from storage bay 380 and moved from bay-to-bay or elsewhere with a forklift like forklift 200. Storage bays like bay 380 are often several levels high. This makes it difficult for the forklift operator to see precisely where he has positioned fork 250 of his forklift 200. Occasionally, when fork 250 is inserted over horizontal beam 315 toward the underside of pallet 331 or cart 340, a tine of a fork 250 will catch a lower lip of a lower apron wall 322 of rail 320. This can result in forming a deformation 323 of lower apron wall 322 of rail 320, when fork 250 is accidentally raised under the lower lip of lower apron wall 322. Such damage to rail 320 can be minor or it can be so significant as to require replacement of rail 320.

Some constructions of storage racks include a faceplate 360 at the front end of bay 380. A gap typically exists between a lower edge of faceplate 360 and horizontal beam 315. Fork 250 can accidentally catch under the lower edge of plate 360. Alternatively, due to the gap between plate 360 and horizontal beam 315, it becomes more likely for fork 250 to find its way under the lower edge of lower apron wall 322. This can lead to the damage discussed above.

Accordingly, it is desirable to provide an improved rack system for storing and transporting pallets of goods that overcomes drawbacks of the prior art and makes it less likely for the support rail structure to become damaged.

### SUMMARY

Generally speaking, in accordance with the invention, an improved storage rack system is provided. The system includes a single level or multilevel horizontal storage bay, extending lengthwise from a front, proximal end to a rear, distal end. Each bay is defined by a series of vertical support columns at the front end. Horizontal connecting beams formed from single pieces or multiple connected pieces extend across the width of the storage bay and connect the vertical columns. A second bay can be positioned directly over or under and/or to the side of the first bay, and so forth. A top edge of the horizontal connecting beam defines a horizontal plane extending into the depth of the storage bay.

From the perspective of viewing into the bay, from front-to-rear, the storage rack system includes a pair of left side and right side support rail structures. Each bay includes a rail structure having a pallet support surface for supporting a side edge of a pallet of goods. Each bay also includes a support rail structure having a pallet cart support surface for supporting the wheels of one side of a pallet transportation cart under the surface for supporting the pallets. The pallet support surface and cart support surface can be part of the same or different supportive members. The pallet transportation carts can transport the pallets of goods into and out of the storage bay or to any position within the storage bay.

In one embodiment of the invention, the support rail structure includes an upper horizontal pallet support surface and a vertical upper wall extending downward from the pallet support surface. The support rail structure can also include a pallet cart support surface under and inward from the pallet support surface. A vertical lower apron wall extends downward from the cart support surface. In one embodiment of the invention, the lower apron wall extends below the horizontal plane defined by the horizontal connecting beam.

In another embodiment of the invention, a gap exists between the lower edge of the apron wall extending downward from the cart support surface and the horizontal plane. A gap cover wall extends from the front end of the lower apron into the storage bay. A lower edge of the gap cover wall extends below the horizontal plane. In one embodiment of the invention, the lower apron wall is separate from, and attached to the support rail having the cart support surface. In this embodiment of the invention, the apron wall extends below the level of the horizontal plane and obstructs the gap.

In a preferred embodiment of the invention, a vertical connection plate couples the support rail to the vertical column. The connection plate is present at the front end of the support rail. In one embodiment of the invention, the connection plate extends downward, below the level of the horizontal plane. In another embodiment of the invention, a front gap exists between a lower edge of the connection plate and the horizontal plane. A front gap plate extends downward from a bottom edge of the connection plate to below the horizontal plane. The front gap plate obstructs the gap and helps prevent the tines of a forklift fork from accidentally entering the gap.

A storage bay in accordance with the invention can be a double bay, without a vertical column between side by side storage rows, each with its own pair of support rails. The lack of the central column permits the use of a double fork forklift, which can remove or load two pallets (or pallet carts) at a time. Each left-side storage row and each right-side storage row can include a pair of support rail structures. Each pair includes a left-side pallet support surface and a right-side pallet support surface. The left-side pallet support surface and the right-side pallet support surface are spaced slightly narrower than the approximate width of a typical pallet (e.g., spaced less than 36″), to provide a surface for supporting the outside edges of a row of pallets extending into the bay. Storage bays in accordance with the invention can be 100, 200, or 250 feet deep, or even deeper. The support rails can be continuous for the length of the bay, or can be provided as bolted or welded together segments. The segments can be provided with a length over 4 feet, preferably over 5 feet long.

The left-side storage row and the right-side storage row can be separated by a central divider. Attached to the central divider can be the right side support rail structure of the left-side storage row and the left side support rail structure of the right-side storage row. There should be no vertical column extending up from the central divider, at least at the front of each bay. The lack of vertical columns can permit the pallets to be stored more closely together and permits use of a double forklift.

The lower portion of the support rail structures should come below a horizontal plane defined by a horizontal connection beam at the front of the bays. A central front plate at the front of the support rails and central rails can also extend down below that plane. If not, a supplemental central cover plate can be added to cover the gap and prevent the tines of a forklift fork from inadvertently slipping into the gap.

Each bay includes a pair of pallet cart support surfaces, extending down the length of the left-side storage row and the right-side storage row. The pallet cart support surfaces are located below and inside the spacing of the pair of left-side pallet support surfaces and right-side pallet support surfaces. A pallet cart, which can be automated, can be provided to move the pallets along the pallet support surfaces and/or collect information regarding the inventory of the pallets. The pallet cart can include wheels designed to ride on the rails. The cart is short enough in height and the wheels on the cart are positioned such that the top of the cart is below a horizontal plane defined by the left-side and right-side pallet support surfaces. Therefore, the cart can travel on the pallet cart support surface, underneath a row of pallets located in the storage bay. It can be used to transport pallets (and goods) throughout the bay.

In one embodiment of the invention, where there is no central column, the left-side and right-side pallet rows should be spaced closely enough so that the pallets can be positioned close enough to be loaded and removed by a dual pallet forklift. Thus, the central divider should be narrow enough to space the pallets close enough to be engaged by a dual fork forklift. In addition, centering cams (guide ramps) can be provided to help properly seat a pallet on the pallet support surface, which may be tens of feet off the ground, as it is loaded into or removed from the bay. The rails and front plates should prevent forklift tines from catching on a lower lip of the rails.

Other objects, advantages and embodiments of the invention will be apparent from the specification and the drawings and the scope of the invention will be indicated in the claims.

### BRIEF DESCRIPTION OF THE DRAWINGS

FIG. 1 is a perspective view of a conventional storage rack system;

FIG. 2 is a perspective view of a forklift;

FIG. 3 is a partial perspective view of a conventional storage bay, showing a damaged support rail;

FIG. 4 is a front view of a dual bay storage rack system in accordance with a preferred embodiment of the invention;

FIG. 5 is a perspective view of a storage bay in accordance with a preferred embodiment of the invention;

FIG. 6 is a partial perspective view of a storage bay in accordance with a preferred embodiment of the invention;

FIGS. 7A, 7B, and 7C are top, side and end views, respectively, of a support rail constructed in accordance with a preferred embodiment of the invention; and

FIG. 8 is a perspective view of a storage bay in accordance with another preferred embodiment of the invention.

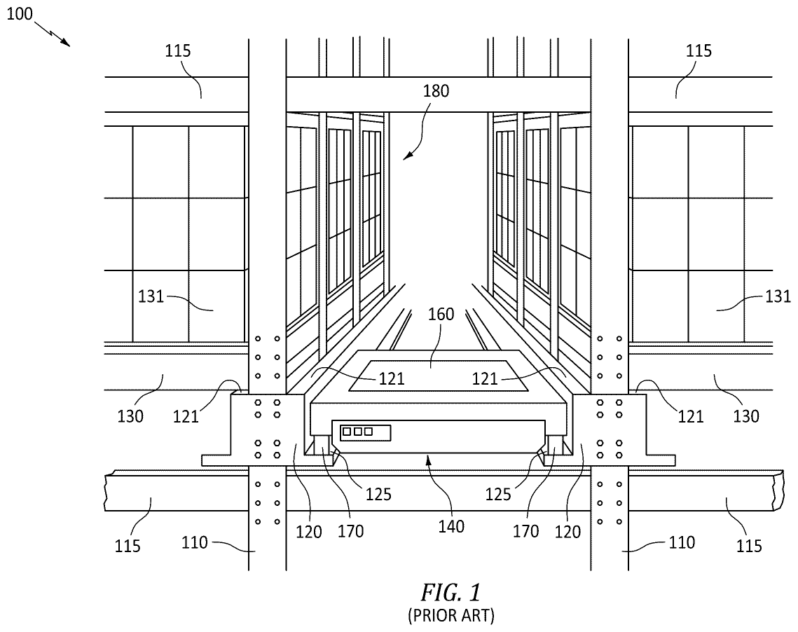

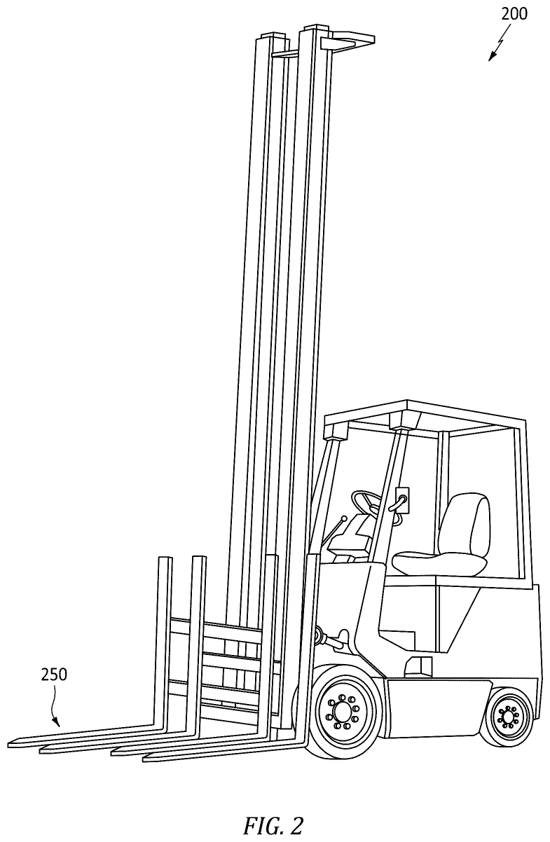

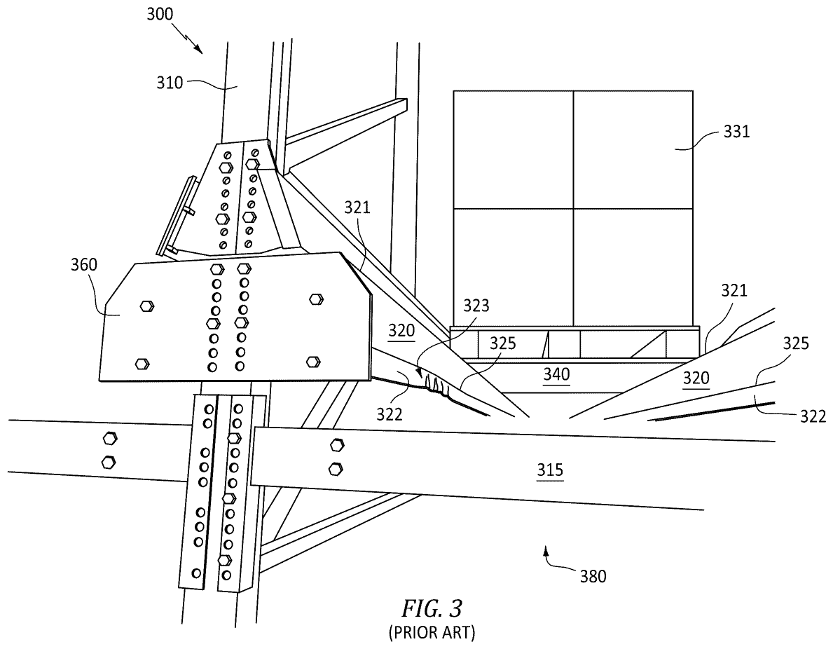

Throughout the specification, like reference numerals will be used to indicate similar elements. The drawings are not necessarily to scale

### DETAILED DESCRIPTION OF THE PREFERRED EMBODIMENTS

The present disclosure may be understood more readily by reference to the following detailed description of the disclosure, taken in connection with the accompanying figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

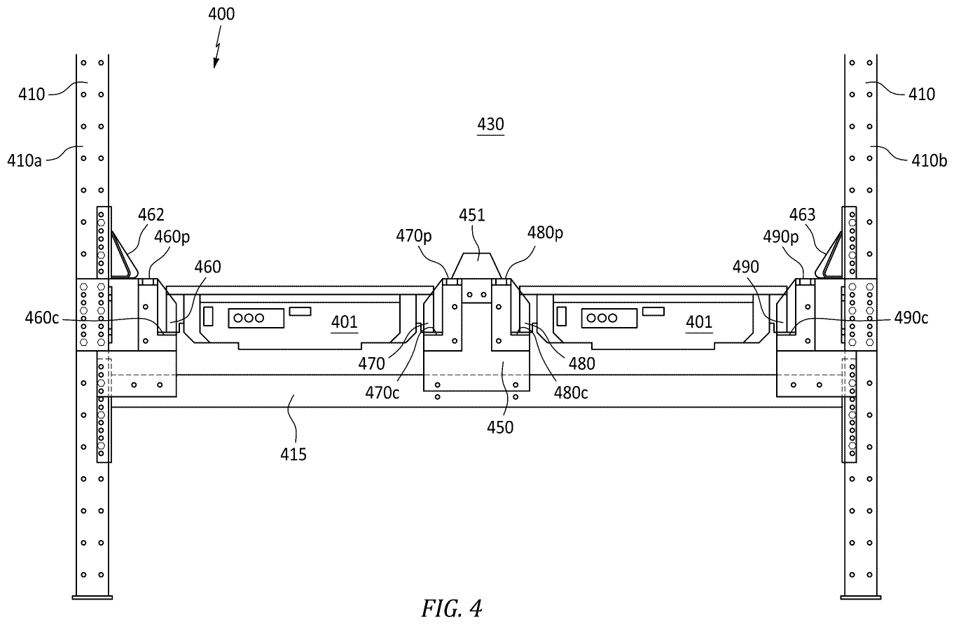

FIG. 4 shows a dual bay rack system 400 in accordance with a preferred embodiment of the invention. Rack 400 includes a plurality of vertical columns 410 coupled together by a corresponding plurality of single piece horizontal connecting beams 415. The pair of vertical columns 410 with the horizontal connecting beam 415 therebetween define a dual pallet storage bay 430. From the perspective of looking lengthwise from a near proximal end to a far distal end, storage bay 430 defines a left side defined by a left vertical column 410a and a right side defined by a right vertical column 410b. A plurality of storage bays similar to bay 430 can be stacked on top of each other and positioned side-to-side with each other. In another embodiment of the invention, a single row storage bay can be constructed with left column 410a and right column 410b and a single row therebetween.

Each storage bay 430 includes a central divider 450, which is supported by horizontal connecting beam 415. Because connecting beam 415 is load bearing, it should be constructed differently than a non-load bearing connecting beam. Connecting beam 415 can be formed of two pieces coupled to central divider 450. Central divider 450 does not have any vertical columns rising therefrom. This permits the use of a dual fork forklift and loading or removing two pallets or pallet carts at a time from storage bay 430.

A left-side outer support rail 460 is attached (bolted) to left vertical column 410a; a right-side outer support rail 490 is attached (bolted) to right vertical column 410b; a left side inner support rail 470 is attached (bolted) to the left side of central divider 450; and a right side inner support rail 480 is attached (bolted) to the right side of central divider 450. A single bay storage rack system in accordance with the invention would be similar to bay 430, but a vertical column would rise at the position of central divider. Thus, each bay would have a vertical column matching left column 410a and right column 410b, with corresponding support rails coupled to the central column.

In one embodiment of the invention, the lowest storage bay does not have a horizontal beam extending across the vertical columns. In this embodiment of the invention, the outer support rails for the lowest bay are attached to the vertical columns as otherwise discussed herein, and the inner support rails are supported by the ground, e.g., resting on the ground/floor or supported by a post or stanchion, which rests on the ground/floor. With this embodiment of the invention, when there are no pallets stored in this lower area and it is convenient to walk through the area or to drive a floor cleaner or other vehicle into the area, without the obstruction of the horizontal beam or otherwise.

Support rails 460, 470, 480, and 490 can be formed with a generally “L” shaped cross-section. Each support rail has an upper pallet support surface 460p, 470p, 480p, and 490p for supporting a side edge of a pallet of goods and a lower pallet cart support surface 460c, 470c, 480c, and 490c for supporting the wheels of a pallet transportation cart 401. In preferred embodiments of the invention, pallet support surface 460p, 470p, 480p or 490p can be formed from a continuous piece of metal with cart surface 460c, 470c, 480c or 490c. Alternatively, they can be formed from separate pieces.

It is preferred to provide each bay 430 with centering (camming) guide ramps, for the proper positioning of the pallets during loading and unloading. This permits narrower bays. Accordingly, center divider 450 includes a two-sided centering guide 451 to help guide the pallets onto a pallet support surface 470p or 480p. Similarly, a left side centering (camming) guide 462 and a right side centering (camming) guide 463 are attached to left column 410a and right column 410b, respectively, to properly position the pallets on pallet support surfaces 460p and 490p, respectively. These camming surfaces also assist in the smooth removal of pallets from the storage bays.

Side centering guide 462 or 463 should have a C-channel construction and is angled from horizontal to provide a camming surface to assist in the proper loading and removal of pallets from bay 430. Preferably, this angle is about 60° to 80°, more preferably 65° to 75° and most preferably, about 68°. Side centering guide 462 or 463 should be about 5 to 8 inches in vertical height, preferably about 6 to 7 inches high.

Each bay 430 should have an inner clearance of about 92 inches to store pallets side-by-side. 90 to 94 inches inner clearance is acceptable, 91-93 is preferred. The height of each bay should be able to store a pallet-plus-goods at least 52 inches high, preferably 55-60 inches. The spacing between the pallet support surfaces should be at least 35 inches, 35-45 inches is preferred, 38-42 inches is more preferred and about 39.5-40.5 inches is most preferred. About 2-6 inches clearance should be provided between the pallets and goods and either the adjacent pallet or the adjacent vertical support. About 3.5-4.5 inches is more preferred.

The respective ends of cart support surfaces 460c, 470c, 480c, and 490c of support rails 460, 470, 480, and 490 should be sufficiently close to each other to permit the pallets in the left and right rows of a bay to be close enough to be accessed by a dual fork forklift. Preferably, the ends of the cart support surfaces should be about 10-15 inches apart, preferably 12-14 inches apart, most preferably 13-13.25 inches. The outer edges of the pallet support surfaces supported by the central divider should be about 6-10, preferably 7-9, most preferably 7.5-8.5 inches apart.

Horizontal connecting beams 415 should be strong enough to hold two pallets plus goods, totaling at least about 2000 pounds each, preferably over about 2500 pounds each and even up to 3000 pounds each. Accordingly, horizontal connecting beams should be formed from 4 gauge, quarter-inch thick steel. The beams should have a C-channel construction for additional strength. In particular, horizontal beam 415 should be formed from ¼ inch hot rolled structural steel with a C-channel structure.

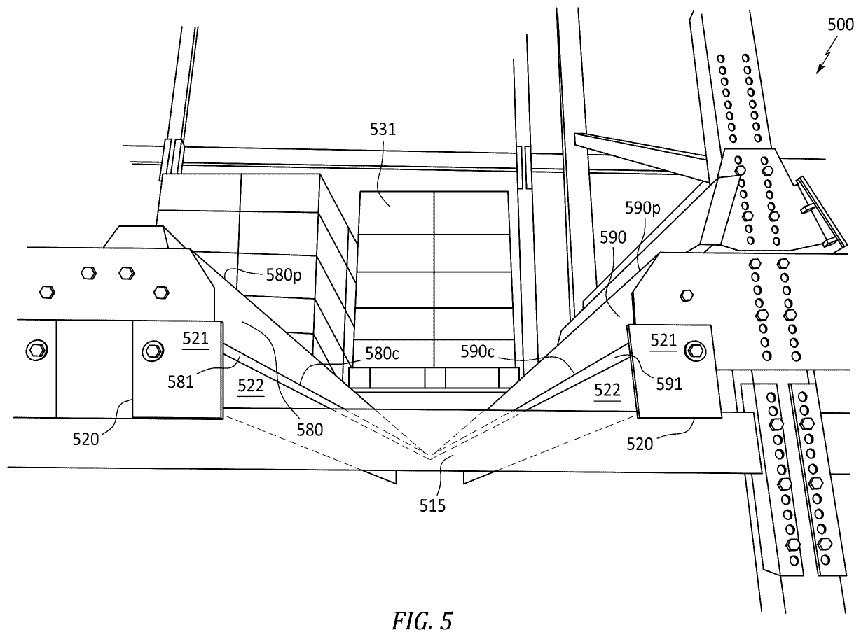

FIG. 5 depicts a rack system 500 similar to rack 400. Rack 500 includes left and right support rail structures 580 and 590, respectively. Support rails 580 and 590 are each formed from a continuous piece of sheet metal, but could be constructed from separate pieces. Support rails 580 and 590 each include a pallet support surface 580p or 590p and a pallet cart support surface 580c or 590c. Support rails 580 and 590 each include a lower apron wall 581 and 591, respectively, extending downward from pallet cart support surfaces 580c and 590c.

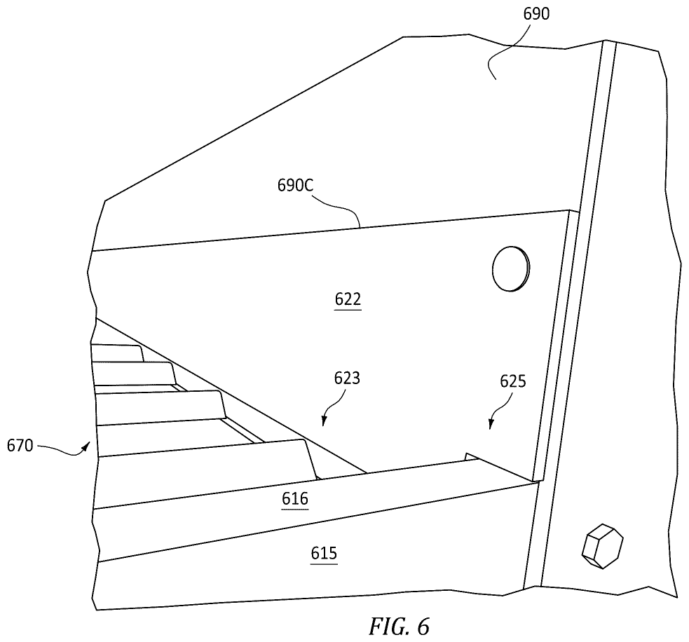

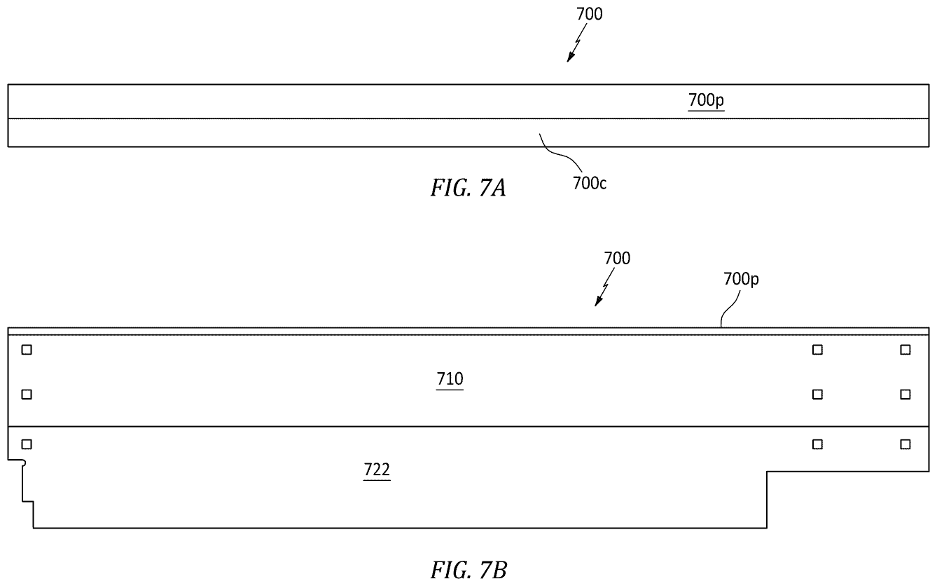

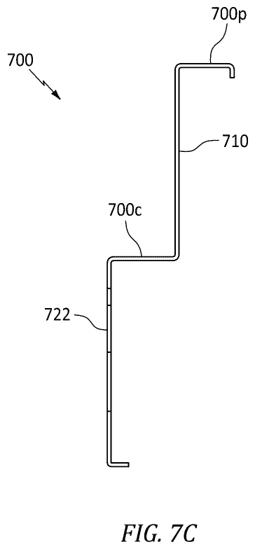

A gap guard 520 is attached (e.g., bolted) over the area below lower apron 581 and 591 of left and right support rails 580 and 590. Gap guard 520 includes a vertical wall 522 and a front cover plate 521. Vertical wall 522 extends from an upper portion of lower apron walls 581 and 591 to a level below a horizontal plane defined by a top edge of horizontal connecting beam 515. A lower edge of front plate 521 extends below the horizontal plane defined by the upper edge of connecting beam 515. An upper edge of front plate 521 can extend above pallet cart support surface 580c or 590c. With gap guard 520 in place, there is no room for the tine of a forklift fork to accidentally slip under or behind support rails 580 or 590. In one embodiment of the invention, vertical wall 522 can be notched, with the upper edge of connecting beam 515 received in the notch (not shown, but see FIGS. 6 and 7). Guard 520 is preferably formed from steel and can have a thickness similar to those of support rails 580 or 590.

FIG. 6 depicts a support rail structure 690 in accordance with another preferred embodiment of the invention. Support rail 690 includes a pallet cart support surface 690c and an upper surface for supporting pallets of goods (not shown) similar to support rail 590 of FIG. 5. Support rail 690 also includes a lower apron wall 622 descending from pallet cart support surface 690c. Lower apron 622 has a large height from top to bottom, and a bottom edge 623 that extends below a horizontal plane defined by a top edge 616 of a connecting beam 615. In a preferred embodiment of the invention, support rail 690 has a notch 625 to receive top edge 616. With the large height of lower apron 622 of support rail 690, there is no room for the tine of a forklift fork to be accidentally inserted over connecting beam 615 and slip underneath lower apron 622. Note that FIG. 6 depicts an optional safety grate 670 to catch a pallet transportation cart if it were to fall off pallet cart support surface 690c.

In one embodiment of the invention, the lower apron is short and does not extend below the horizontal plane, such as in a conventional installation. A gap cover panel can be installed over the gap. The cover panel can be steel similar to the steel of the short apron. A bottom edge of the cover panel extends below the horizontal plane. The cover panel is preferably at least 4 inches tall.

A support rail 700 in accordance with a preferred embodiment of the invention is shown in FIGS. 7A-7C. Support rail 700 includes a pallet support surface 700p, for supporting the edges of pallets of goods. Support rail 700 includes an upper vertical wall 710 that the extends down from pallet support surface 700p. A pallet cart support surface 700c extends horizontally from a lower end of upper wall 710. A lower apron wall 722 extends downward from pallet cart support surface 700c. Lower apron 722 should be made long enough to prevent the tines of a forklift fork from inadvertently slipping behind or under lower apron 722. In another embodiment of the invention, the front end of lower apron 722 can include a tab, extending either over a front plate at the front and of rail 700 or behind the front plate to add strength and two further prevent the forklift tine from slipping behind rail 700. The right side of lower apron 722 shows a notch to receive a horizontal connecting beam.

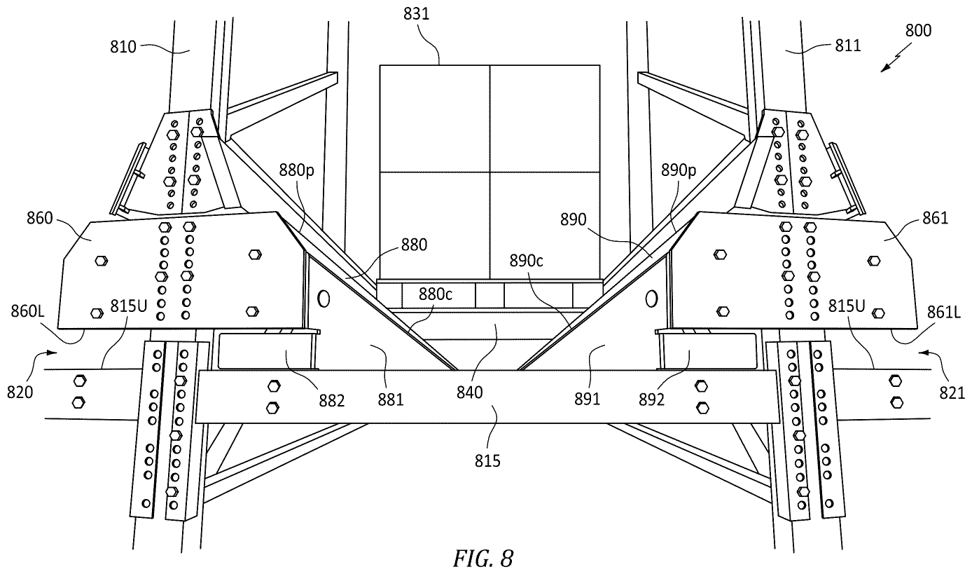

FIG. 8 depicts a rack system 800 that is similar to racks 400 and 500. Rack 800 includes a left-side vertical column 810 and a right-side vertical columns 811. A left front plate 860 is attached to left vertical column 810 and a right front plate 861 is attached to right vertical column 811. A left rail structure 880 extends back from left front plate 860 and a right rail structure 890 extends back from right front plate 861. Support rails 880 and 890 are each preferably formed from a continuous sheet of metal, but could be constructed by joining separate pieces.

Support rails 880 and 890 each include a pallet support surface 880p and 890p for supporting a pallet of goods 831 and a pallet cart support surface 880c and 890c for supporting the wheels of a pallet cart 840. Support rails 880 and 890 each include a lower apron wall 881 and 891, respectively, extending downward from pallet cart support surfaces 880c and 890c. A horizontal beam 815 connects left column 810 to right column 811 and defines a horizontal plane.

As shown in FIG. 8, a gap 820 exists between a lower edge 860L of front plate 860 and an upper edge 815U of horizontal beam 815. A tab 882 extends horizontally from a front end of lower apron 881. Tab 882 can fit within gap 820, or it can extend below upper edge 815U, behind horizontal beam 815. In another embodiment of the invention, lower wall 881 can be notched over horizontal beam 815 and tab 882 can extend horizontally, in front of horizontal beam 815. Likewise, lower apron 891 includes a similar tab 892, which obstructs a gap 821 between a lower edge 861L of front plate 861 and upper edge 815U. With tabs 882 and 892 obstructing gaps 820 and 821, there is no room for the tine of a forklift fork to accidentally slip under or behind front plates 860 or 861, or behind support rails 880 or 890.

Support rails in accordance with the invention should have a thickness at least as large as that of 12 gauge steel. Preferably, the thickness should be in the range of 0.1 to 0.15 inches. A thickness of about 10 gauge or 0.135 inches is preferred. The bottom edge of the lower apron portion preferably includes a bend, to create a right angle and provide strength to resist deformation. The height of the lower apron should be more than 5.5 inches, preferably more than 6 inches, and most preferably more than 7 inches.

Note that where this application has listed the steps of a method or procedure in a specific order, it may be possible, or even expedient in certain circumstances, to change the order in which some steps are performed, and it is intended that the particular steps of the method or procedure claim set forth here below not be construed as being order-specific unless such order specificity is expressly stated in the claims.

While the preferred embodiments of the devices and methods have been described in reference to the environment in which they were developed, they are merely illustrative of the principles of the inventions. Modification or combinations of the above-described assemblies, other embodiments, configurations, and methods for carrying out the invention, and variations of aspects of the invention that are obvious to those of skill in the art are intended to be within the scope of the claims.

What is claimed is:

1. A commercial storage rack, comprising:
a pair of vertical columns defining a front end of a storage bay, a horizontal inward direction from one column to the other, and a horizontal length direction perpendicular from the inward direction, extending from the front end to a rear end of the storage bay;
a horizontal beam structure connecting the vertical columns, and a top edge of the horizontal beam defining a horizontal plane;
a horizontal support rail structure coupled to each column, perpendicular to the horizontal beam and extending in the length direction towards the rear of the storage bay, each support rail structure comprising:
(i) a pallet support surface on the top thereof adapted to support one side of a pallet of goods,
(ii) a vertical wall extending vertically downward from the pallet support surface,
(iii) a pallet cart support surface below the pallet support surface extending horizontally inward, the pallet cart support surface adapted to support the wheels of a pallet transportation cart, and
(iv) a lower apron wall, extending vertically downward from the pallet cart support surface to a position below the horizontal plane.

2. The storage rack of claim 1, wherein the lower apron extends to a distance more than 5.5 inches below the pallet cart support surface.

3. The storage rack of claim 1, wherein the lower apron extends to distance more than 6 inches below the pallet cart support surface.

4. The storage rack of claim 1, wherein the support rail structure comprises steel having a thickness of at least 0.1 inches.

5. The storage rack of claim 1, wherein a front end of the lower apron includes a horizontally extending tab, the tab extending in an outward direction opposite the inward direction.

6. The storage rack of claim 1, wherein a front end of the lower apron includes a notch and the horizontal beam is received in the notch.

7. The storage rack of claim 1, and including a vertical front plate at a front end of the support rail structure, perpendicular to the length direction and the horizontal plane, and the front end of the lower apron includes a tab extending opposite the inward direction, the tab extending in front of the front plate.

8. The storage rack of claim 1, and including a vertical front plate at a front end of the support rail structure, perpendicular to the length direction and the horizontal plane, and the front end of the lower apron includes a tab extending opposite the inward direction behind the front plate.

9. The storage rack of claim 1, wherein a lower end of the lower apron bends substantially horizontally, opposite the inward direction. at an approximate right angle to an upper portion of the lower apron.

10. The storage rack of claim 1, wherein the front end of the support rail structure is attached to the columns with a vertical connection plate therebetween, and a gap exists between a bottom edge of the connection plate and the top edge of the horizontal beam, and a front gap cover plate obstructs the gap between the bottom edge of the connection plate and the top edge of the horizontal beam.

11. A commercial storage rack comprising:
a pair of vertical columns defining a front end of a storage bay, a horizontal inward direction from one column to the other, and a horizontal length direction perpendicular from the inward direction, extending horizontally from the front end to a rear end of the storage bay;
a horizontal beam structure connecting the vertical columns, a top edge of the horizontal beam structure defining a horizontal plane;
a horizontal support rail structure coupled to each column, the support rail extending in the length direction into the storage bay in a direction perpendicular to the horizontal beam, the support rail structure including a pallet support surface on an upper surface thereof adapted to support one side of a pallet of goods, a pallet cart support surface extending inwardly at a level below the pallet support surface, the pallet cart support surface adapted to support the wheels of a pallet transportation cart, and a short apron wall, extending downward from the pallet cart support surface to a position above the horizontal plane with a gap between a bottom edge of the short apron wall and the horizontal plane; and
a rail gap guard extending horizontally in the length direction along the short apron from the front of the support rail and extending vertically downward from the bottom edge of the short apron to a position below the horizontal plane and obstructing the gap.

12. The storage rack of claim 11, wherein the front end of the support rail structure is attached to the column with a vertical connection plate therebetween, and a gap exists between a bottom edge of the connection plate and the top edge of the horizontal beam, wherein a front gap cover plate obstructs the gap between the bottom edge of the connection plate and the top edge of the horizontal beam.

13. The storage rack of claim 11, wherein the bottom edge of the rail gap guard extends to a distance more than 5.5 inches below the pallet cart support surface.

14. The storage rack of claim 11, wherein the support rail structure comprises steel having a thickness of at least 0.1 inches.

15. The storage rack of claim 11, wherein a front end of the rail gap guard includes a horizontally extending tab, the tab extending in an outward direction opposite the inward direction.

16. The storage rack of claim 11, wherein a front end of the rail gap guard includes a notch and the horizontal beam is received in the notch.

17. The storage rack of claim 1, wherein a lower end of the rail gap guard bends substantially horizontally, opposite the inward direction. at an approximate right angle to an upper portion of the rail gap guard.

18. The storage rack of claim 11, wherein the front end of the support rail structure is attached to the columns with a vertical connection plate therebetween, and a gap exists between a bottom edge of the connection plate and the top edge of the horizontal beam, and a front gap cover plate obstructs the gap between the bottom edge of the connection plate and the top edge of the horizontal beam.

19. A support rail extending at least four feet in a length direction, comprising:
a horizontal pallet support upper surface having a front top edge and a rear top edge defining a front direction from the rear top edge to the front top edge, the front top edge and rear top edge separated by a pallet support surface width, and extending at least 4 feet in the length direction perpendicular to the front direction;
the rear top edge bending downward at approximately a right angle to the pallet support surface to form a rear upper lip;
an upper vertical wall extending downward from the front top edge for a second distance from the front top edge to a pallet cart support surface extending horizontally in the front direction from a lower end of the upper vertical wall to a front lower edge of the pallet cart support surface;
a lower apron wall extending downward from the front lower edge to an apron lower edge of the lower apron for a lower apron distance of at least 5.5 inches; and
a lower lip extending opposite the front direction at substantially a right angle to the apron wall at a lower end of the lower apron wall.
